(19) United States
(12) Patent Application Publication
(10) Pub. No.: US 2006/0139800 A1
(43) Pub. Date: Jun. 29, 2006

(54) Disk drive device, disk drive apparatus with the same, and method of manufacturing disk driving device

(75) Inventor: Atsushi Takahashi, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/311,375

(22) Filed: Dec. 20, 2005

(30) Foreign Application Priority Data
Dec. 28, 2004 (JP) 2004381056

(51) Int. Cl. G11B 17/02

(52) U.S. Cl. 360/99.12

(57) ABSTRACT

A disk drive device has a substantially cylindrical hub supported rotatably by a pivot. A disk is fitted on the hub coaxially with a ring shaped spacer and a clamp member mounted on the end portion of the hub. The spacer has a contact portion which contacts with the disk, and the clamp member is fitted on the hub by a shrinkage fitting and holds the spacer in a state contacting with the disk. One of the spacer and the clamp member has an engaging portion which engages with the other member at the time of the shrinkage fitting of the clamp member, and the other one has a guide surface which contacts with the engaging portion and guides the spacer in a direction wherein a center of the contact portion coincides with the rotation center of the hub by contacting with the engaging portion.

### CROSS-REFERENCE TO RELATED APPLICATIONS

This application is based upon and claims the benefit of priority from prior Japanese Patent Application No. 2004-381056, filed Dec. 28, 2004, the entire contents of which are incorporated herein by reference.

### BACKGROUND OF THE INVENTION

1. Field of the Invention

The present invention relates to a disk drive device which supports and drives a disk as a recording medium, a disk apparatus comprising the same, and a method for manufacturing a disk drive device.

2. Description of the Related Art

Recently, as an external recording device for a computer or an image recording device, disk apparatuses such as a magnetic disk device and an optical disk device have been used widely.

In general, a magnetic disk apparatus, for example, comprises a rectangular box shaped housing. In the housing, a magnetic disk as a magnetic recording medium, a disk drive device for supporting and rotating the magnetic disk, a plurality of magnetic heads for writing and reading information with respect to the magnetic disk, a head actuator for supporting the magnetic heads movably with respect to the magnetic disk, a voice coil motor for rotating and positioning the head actuator, a board unit comprising a head IC, or the like are stored.

On the outer surface of the housing is screwed a printed circuit board for controlling the operation of the spindle motor, the voice coil motor, and the magnetic head via the board unit. An interface (I/F) connector for connecting the magnetic disk apparatus with the other external appliances is mounted on the end portion of the printed circuit board.

For example, a disk drive device disclosed in Jpn. Pat. Appln. KOKAI Publication No. 8-297944 comprises a spindle motor for supporting and rotating a magnetic disk. The spindle motor has a substantially cylindrical hub constituting a rotor and a magnetic disk is fitted onto the outer circumference of the hub. A clamp ring is fitted to the outer circumference of one end of the hub for preventing fall off of the magnetic disk. An annular spacer is fitted to the outer circumference of the hub and disposed between the magnetic disk and the clamp ring so as to be pressed against the magnetic disk by the clamp ring. Thereby, the magnetic disk can be fixed with respect to the hub. The clamp ring is fitted to the hub by the so-called shrinkage fitting. That is, the clamp ring is fitted to the hub with being previously heated and expanded, and then cooled to shrink, thereby being fitted with a desired fit.

According to the disk driving device with the above-mentioned configuration, the contact diameter center of the spacer and the disk has the displacement with respect to the contact diameter center of the hub and the disk due to the gap between the inner diameter of the spacer and the outer diameter of the hub. Therefore, a moment load is applied to the clamp portion of the disk so as to deform the disk. In the case the disk is deformed, deterioration of the head positioning accuracy with respect to the disk, deterioration of the recording accuracy, or the like are brought about.

The above-mentioned gap is influenced significantly by the size and the process accuracy of the spacer inner diameter, the size and the process accuracy of the hub outer diameter, and the position of the spacer diameter direction positioned at the time of fixing by shrinkage fitting. In order to alleviate the center displacement as mentioned above, it is necessary to prevent the gap generation with respect to the hub outer diameter by improving the spacer inner diameter size accuracy. However, in this case, the problems are involved in that the parts accuracy administration is extremely difficult, and the hub insertion to the spacer is difficult due to the smallness of the gap.

### BRIEF SUMMARY OF THE INVENTION

A disk drive device according to an aspect of the invention comprises: a spindle motor having a pivot and a substantially cylindrical hub configuring a rotor and supported rotatably on the pivot; a disk shaped recording medium fitted coaxially to an outer circumference of the hub; an elastic annular spacer including a contact portion which is in contact with the recording medium, and mounted on an end portion of the outer circumference of the hub with a gap; and a ring shaped clamp member fitted to the end portion of the outer circumference of the hub by a shrinkage fitting, the clamp member holding the spacer in a state contacted with the recording medium. One of the spacer and clamp member has an engaging portion which engages with the other member at the time of the shrinkage fitting of the clamp member, and the other of the spacer and clamp member has a guide surface which contacts with the engaging portion of the member and guides the spacer in a direction wherein a center of the contact portion of the spacer coincides with a rotation center of the hub.

According to another aspect of the invention, there is provided a disk apparatus comprising: a case; the disk drive device according to any of claims 1 to 5, arranged in the case; a head which performs information processing on the recording medium; and a head actuator which is arranged in the case and movably supports the head with respect to the recording medium.

According to another aspect of the invention, there is provided a method of manufacturing a disk drive device comprising a spindle motor having a pivot and a substantially cylindrical hub configuring a rotor and supported rotatably on the pivot; a disk shaped recording medium fitted coaxially to an outer circumference of the hub; an elastic annular spacer including a contact portion which is in contact with the recording medium, and mounted on an end portion of the outer circumference of the hub with a gap; and a ring shaped clamp member fitted to the end portion of the outer circumference of the hub by a shrinkage fitting, the clamp member holding the spacer in a state contacted with the recording medium, the method comprising:

fitting the recording medium to the outer circumference of the hub of the spindle motor; mounting the spacer onto an end portion of the outer circumference of the hub with a gap and bringing the contact portion of the spacer to contact with the recording medium; and fitting the clamp member on the end portion of the outer circumference of the hub by a shrinkage fitting, and at the time, contacting an engaging portion provided on one of the spacer and the lamp member with a guide surface provided on the other so as to guide the spacer in a direction wherein a center of the contact portion of the spacer coincides with a rotation center of the hub for positioning.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred to as an HDD) according to a first embodiment of the present invention;

FIG. 2 is an exploded perspective view of the HDD;

FIG. 3 is a plan view showing a case and the internal structure of the HDD;

FIG. 4 is a cross-sectional view of the HDD taken along the line A-A in FIG. 1;

FIG. 5 is a side view showing a radial dynamic pressure generating section of a fluid bearing in the HDD;

FIG. 6 is a cross-sectional view showing a thrust dynamic pressure generating section of a fluid bearing in the HDD;

FIG. 7 is an exploded perspective view showing a disk drive device of the HDD;

FIG. 8 is a cross-sectional view showing a clamp member of the disk drive device in an enlarged state;

FIG. 9 is a cross-sectional view showing the assembly process of the disk drive device;

FIG. 10 is a cross-sectional view showing the assembly process of the disk drive device;

FIG. 11 is a cross-sectional view showing a disk drive device for a HDD according to a second embodiment of the present invention; and

FIG. 12 is a cross-sectional view showing a disk drive device for a HDD according to a third embodiment of the present invention.

### DETAILED DESCRIPTION OF THE INVENTION

Hereinafter, with reference to the drawings, an HDD according to an embodiment of the present invention will be explained in detail.

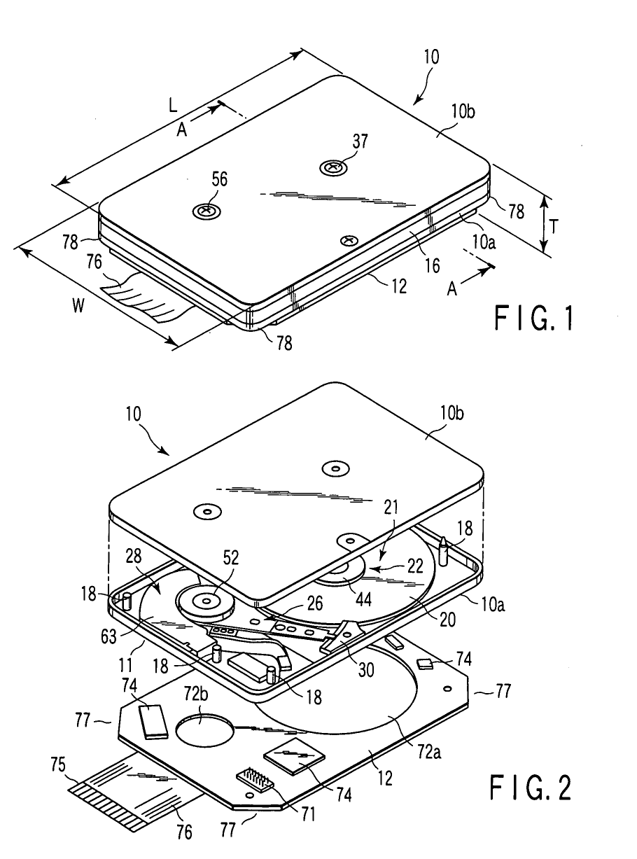

As shown in FIGS. 1 and 2, the HDD comprises a case 10 in the form of a substantially rectangular box and a rectangular control circuit board 12. The case 10 contains various members, which will be described later. The circuit board 12 is overlapped on the outer surface of the case 10. The case 10 and the circuit board 12 each have a length L of 32 mm and a width W of 24 mm. A thickness T of a structure that combines the case and the control circuit board ranges from 3 to 6 mm. The thickness T is adjusted to, e.g., about 3.3 mm or 5 mm, depending on the number of disks to be held in the case.

As shown in FIGS. 2 to 4, the case 10 comprises a first shell 10a and a second shell 10b that have substantially equal dimensions. The first and second shells 10a and 10b are substantially rectangular metallic structures, which have sidewalls set up on their respective peripheral edge portions. The shells 10a and 10b are arranged facing each other with their peripheral edge portions opposed. A belt-shaped seal member 16 is wound around the peripheral edge portions of the shells 10a and 10b. The seal member 16 connects the peripheral edge portions of the shells and seals a gap between them. Thus, the case 10 is formed having the shape of a rectangular box.

The bottom surface of the first shell 10a forms a rectangular mounting surface 11. Four corners of the case 10, including the corners of the mounting surface 11, are rounded in a circular arc. Thus, the seal member 16 that is wound around the peripheral edge portion of the case 10 is prevented from being damaged by the corners of the case, and air-tightness is prevented from being lowered by lifting of the seal member.

In the case 10, a plurality of support posts 18 are provided on the peripheral edge portion of the case. Each support post 18 has a proximal end fixed to the inner surface of the first shell 10a and is set substantially upright on the inner surface of the first shell. Corresponding to each support post 18 in position, a tapped hole is formed in the mounting surface 11 and extends into the post.

The case 10 contains a magnetic disk 20 of, e.g., 0.85-inch diameter, for use as an information recording medium, a disk drive device 21, a magnetic head 24, and a carriage 26. The spindle motor 22 supports and rotates the disk. The magnetic head 24 is used to write and read information to and from the disk. The carriage 26 supports the magnetic head 24 for movement with respect to the magnetic disk 20. Further, the case 10 contains a voice coil motor (hereinafter referred to as a VCM) 28, a ramp load mechanism 30, a solenoid latch 32, a board unit 34, etc. The VCM 28 rotates and positions the carriage 26. The ramp load mechanism 30 unloads into and holds the magnetic head 24 in a position off the magnetic disk 20 when the head is moved to the peripheral edge portion of the disk. The solenoid latch 32 holds the carriage 26 in a shunt position. The board unit 34 has a head IC and the like.

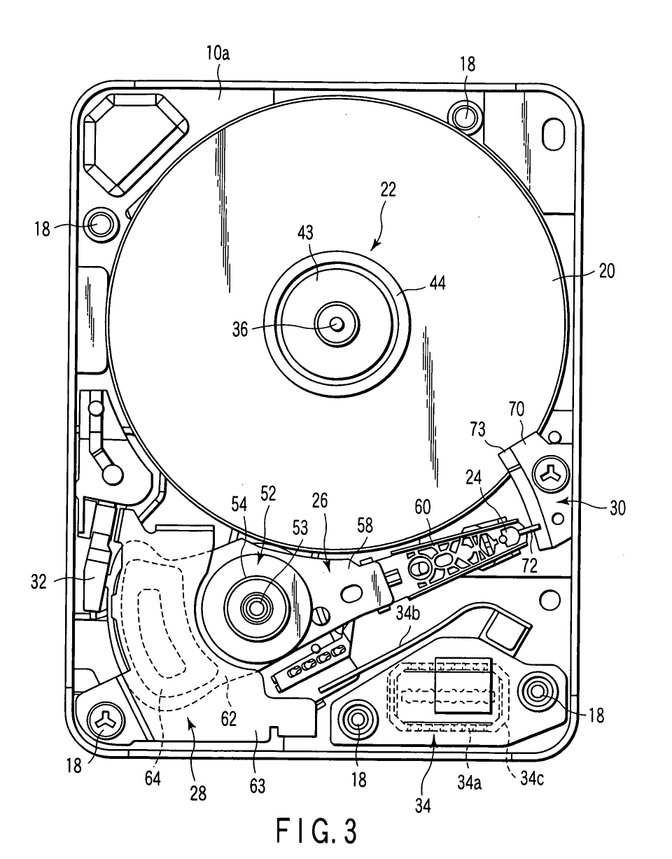

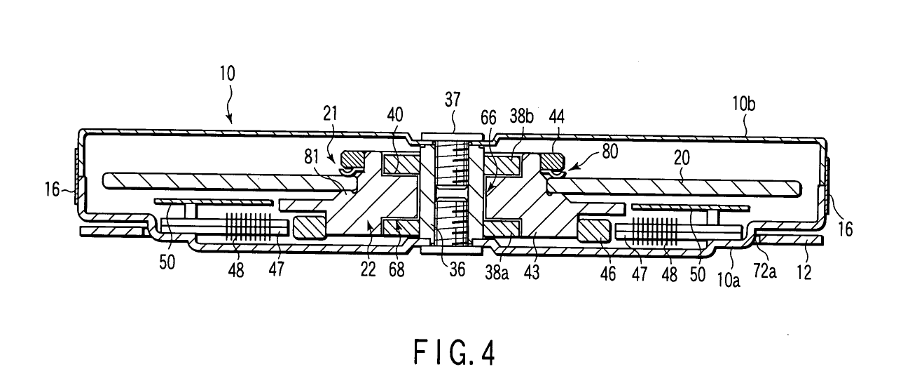

As shown in FIGS. 3 and 4, the disk drive device 21 includes a spindle motor 22 mounted on the first shell 10a. The spindle motor 22 has a pivot 36, which is fixed to the inner surface of the first shell 10a and set substantially upright on it. An extended end of the pivot 36 is screwed to the second shell 10b by a fixing screw 37 that is externally screwed into the second shell. Thus, the pivot 36 is dually supported by the first and second shells 10a and 10b.

A substantially cylindrical hub 43, which constitute a rotor, is rotatably supported on the pivot 36 by a fluid bearing. Specifically, ring shaped flange members 38a, 38b are coaxially fitted on the both end portions of the pivot 36. The inner surface of the hub 43 is formed in a shape corresponding to the shape of the pivot 36 and the flange members 38a, 38b so as to face the same with a minute gap of about 2 to 15 μm defined therebetween. The minute gap between the pivot 36, and the flange members 38a, 38b and hub 43 is filled with a lubricant 40 as a dynamic pressure generating fluid.

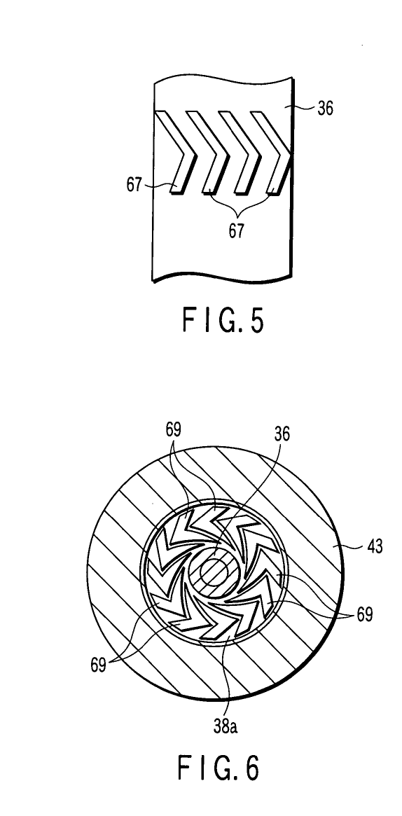

A radial dynamic pressure generating section 66 is provided in the minute gap between the outer peripheral surface of the pivot 36 and the inner circumferential surface of the hub 43. A thrust dynamic pressure generating section 68 is formed in the minute gap between the upper surface of the lower flange member 38a and the hub 43. As shown in FIG. 5, the radial dynamic pressure generating section 66 has a plurality of radial dynamic pressure generating grooves 67, e.g., herring bone grooves, formed on the outer peripheral surface of the pivot 36. The radial dynamic pressure generating grooves 67 are formed over the entire circumference of the pivot 36 side by side in the circumferential direction. When the hub 43 is rotated, the radial dynamic pressure generating grooves 67 generate the dynamic pressure in the radial direction by the lubricant 40 filled in the minute gap.

As shown in FIG. 6, the thrust dynamic pressure generating section 68 has a plurality of thrust dynamic pressure generating grooves 69 formed on the upper surface of the flange member 38a. The thrust dynamic pressure generating grooves 69 comprises herring bone grooves formed side by side in the circumferential direction around the pivot 36. When the hub 43 is rotated, the thrust dynamic pressure generating grooves 69 generate the dynamic pressure in the thrust direction by the lubricant 40 filled in the small gap.

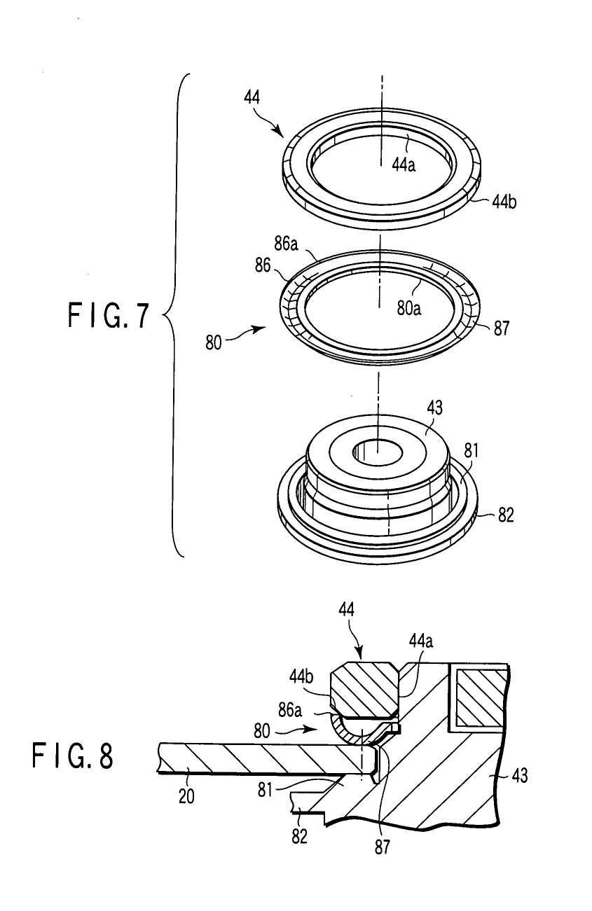

As shown in FIGS. 3, 4, 7 and 8, the magnetic disk 20 is fitted coaxially to the end portion on the second shell 10b side of the hub 43. A ring shaped clamp spring 80 serving as a spacer is fitted to the end portion of the hub 43 and a clamp ring 44 is fitted to the hub 43 over the clamp spring 80. An annular flange 82 is formed integrally to the middle portion of the hub 43 and a disk placing portion 81 formed of a ring shaped projection is provided on the flange 82. The disk placing portion 81 is formed coaxially with the rotation center of the hub 43. The inner circumferential edge portion of the magnetic disk 20 and the clam spring 80 are pressed by the clamp ring 44 for preventing the fall off. Moreover, the inner circumferential edge portion of the magnetic disk 20 is forced by the clamp spring 80 in the axial direction of the pivot 36 so as to be pressed against the disk placing portion 81 of the hub 43. Thereby, the magnetic disk 20 is fixed to the hub 43 and supported rotatably with the hub.

The elastic clamp spring 80 is made of for example a stainless steel. The clamp spring 80 integrally comprises an inner hole 80a through which the upper end portion of the hub 43 is inserted with a gap, an annular contact portion 87 located on the radially outside of the inner hole, and an outer peripheral rim portion 86 disposed coaxially with the contact portion 87 and the radially outside of the contact portion 87. The contact portion 87 has an arc shaped cross section projecting toward the magnetic disk 20 with the projecting end and elastically contacts with the inner circumferential edge portion of the magnetic disk 20 surface. The outer peripheral rim part 86 constitutes an engaging portion 86a to be engaged with the clamp ring 44.

The clamp ring 44 serving as the clamp member is formed in an annular shape with the same material as the clamp spring 80, for example, a stainless steel. The clamp ring 44 and the clamp spring 80 need not be formed with the same material but they may be formed with materials different from each other so that the materials can be selected freely. The clamp ring 44 includes an inner circumferential surface 44a fitted with the outer peripheral surface of the upper end portion of the hub 43, and a tapered guide surface 44b formed on the outer peripheral edge portion on the side facing the clamp spring 80 and disposed coaxially with the hub 43.

The clamp ring 44 is fitted to the end portion of the outer circumference of the hub 43 by the so-called shrinkage fitting. That is, the clamp ring 44 is fitted to the hub 43 by desired fit by fitting the clamp ring to the hub with being previously heated and expanded state and then cooled down for shrinking the clamp ring. Then, the guide surface 44b of the clamp ring 44 contacts with the engaging portion 86a of the clamp spring 80 and presses the clamp spring 80 to the magnetic disk 20 side via the engaging portion 86a.

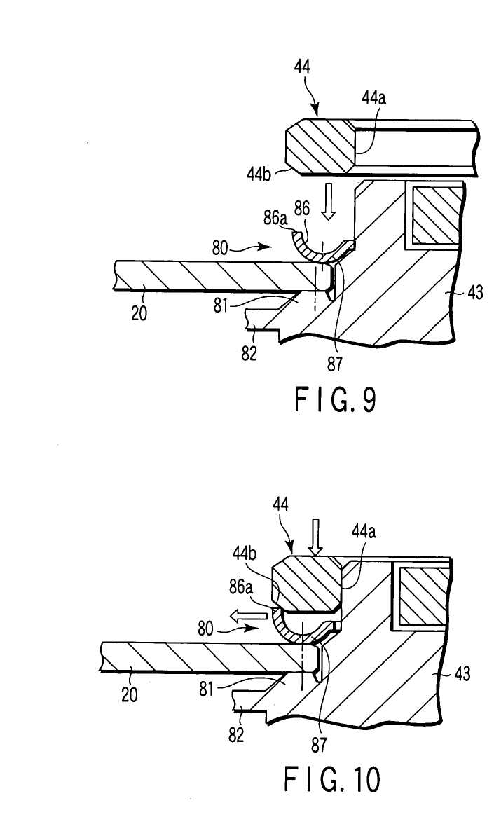

At the time of assembling the disk drive device 21, as shown in FIG. 9, first, the magnetic disk 20 is fitted to the outer circumference of the hub 43 of the spindle motor 22 as well as the inner circumferential edge portion of the lower surface of the magnetic disk is placed on the disk placing portion 81. Then, the clamp spring 80 is mounted on the outer circumference of the end portion of the hub 43 with a gap and the contact portion 87 of the clamp spring is brought into contact with the inner circumferential edge portion of the upper surface of the magnetic disk 20. Thereafter, the clamp ring 44 is fitted to the outer circumference of the end portion of the hub 43 from above by the shrinkage fitting. At the time, as shown in FIG. 10, by moving the clamp ring 44 toward the clamp spring 80 side in a state with the guide surface 44b bringing into contact with the engaging portion 86a of the clamp spring 80, thus the tapered guide surface 44b and the engaging portion 86a are moved relatively. Thereby, the clamp spring 80 is guided and positioned to the direction with the center of the contact portion 87 of the clamp spring 80 coinciding with the rotation center of the hub 43.

By the above-mentioned process, the inner circumferential edge portion of the magnetic disk 20 is clamped between the disk placing portion 81 of the hub 43 and the contact portion 87 of the clamp spring 80 so that the magnetic disk 20 is coaxially fixed to the hub 43. At the same time, according to the relative movement of the tapered guide surface 44b and the engaging portion 86a, the center of the contact portion 87 of the clamp spring 80 coincides accurately with the rotation center of the hub 43 and the center of the disk placing portion 81. Thereby, the contact diameter center of the clamp spring 80 and the magnetic disk 20 coincides with the contact diameter center of the hub 43 and the magnetic disk 20 so that the magnetic disk 20 is stably supported without generating deformation of the magnetic disk.

As shown in FIG. 4, a ring shaped permanent magnet 46 is fixed to the end portion on the first shell 10a side of the hub 43 and disposed coaxially with the hub 43. The spindle motor 22 comprises a stator core 47 mounted on the first shell 10a, and a plurality of coils 48 wound around the stator core such that the stator core and the coils are disposed on the outer side of the permanent magnet 46 with a gap. An annular shielding plate 50 is mounted on the first shell 10a and disposed between the coils 48 and the magnetic disk 20.

The first shell 10a has a plurality of through holes (not shown) facing the lower surface of the hub 43. At the time of mounting the magnetic disk 20 and the clamp ring 44 on the hub 43, a supporting rod as a jig can be inserted from the outside of the case 10 through the through holes so as to support the hub 43 by the supporting rod. Thereby, the magnetic disk 20 and the clamp ring 44 can be mounted without damaging the fluid bearing.

As shown in FIGS. 2 and 3, the carriage 26 having the head actuator includes a bearing assembly 52 mounted on the inner surface of the first shell 10a. The bearing assembly 52 comprises a pivot 53 provided upright perpendicularly with respect to the inner surface of the first shell 10a, and a cylindrical sleeve 54 rotatably supported by the pivot 53 via a pair of bearings. The extended end of the pivot 53 is screwed to the second shell 10b by a fixing screw 56 screwed from the outside of the second shell 10b. Thus, the pivot 53 is supported by the first and second shells 10a, 10b from the both sides. The bearing assembly 52 serving as the bearing is arranged side by side with the spindle motor 22 in the longitudinal direction of the case 10.

The carriage 26 includes an arm 58 extending from the sleeve 54, an elongated plate shaped suspension 60 extending form the distal end of the arm, and a supporting frame 62 extending from the sleeve 54 in a direction opposite to the arm. The magnetic head 24 is supported by the extended end of the suspension 60 via a gimbal part (not shown). The magnetic head 24 is applied with a predetermined head load toward the surface of the magnetic disk 20 by the spring force of the suspension 60. A voice coil 64 constituting a part of the VCM 28 is fixed integrally to the supporting frame 62.

The VCM 28 for rotating the carriage 26 around the bearing assembly 52 comprises a pair of yokes 63 fixed on the first shell 10a facing with each other with a gap, and a magnet (not shown) fixed on the inner surface of one of the yokes and facing the voice coil 64. By energizing the voice coil 64, the carriage 26 is rotated between a retreated position shown in FIG. 3 and an operation position on the surface of the magnetic disk 20, and positions the magnetic head 24 on a desired track of the magnetic disk 20. The electromagnetic latch 32 fixed on the first shell 10a latches the carriage 26 moved to the retreated position and prevents the movement of the carriage 26 from the retreated position to the operation position at the time an external force such as the impact is applied to the HDD.

The lamp load mechanism 30 comprises a lamp member 70 fixed on the inner surface of the first shell 10a facing the circumferential edge of the magnetic disk 20, and a tub 72 extending form the distal end of the suspension 60 so as to serve as an engaging member. The lamp member 70 is formed by bending a plate member and has a lamp surface 73 which is designed to engage with the tub 72. When the carriage 26 is rotated from the inner circumferential portion of the disk 20 to the retreated position on the outside of the outer periphery of the magnetic disk 20, the tube 72 is engaged with the lamp surface 73 of the lamp member 70, and then lifted up by the inclination of the lamp surface so as to carry out the unloading operation of the magnetic head 24. At the time the carriage 26 is rotated to the retreated position, the tub 72 is supported on the lamp surface 73 of the lamp member 70 so that the magnetic head 24 is maintained in a state away from the magnetic disk 20 surface.

The substrate unit 34 has a body 34a that is formed of a flexible printed circuit board. The body 34a is fixed to the inner surface of the first shell 10a. Electronic components, such as the head IC, a temperature sensor, etc., are mounted on the body 34a. The substrate unit 34 has a main flexible printed circuit board (hereinafter referred to as a main FPC) 34b that extends from the body 34a. An extended end of the main FPC 34b is connected to that part of the carriage 26 which is situated near the bearing assembly 52. Further, the extended end of the main FPC 34b is connected electrically to the magnetic head 24 by a cable (not shown) that is located on the arm 58 and the suspension 60. A connector 34c for connection with the control circuit board 12 is mounted on the bottom surface of the body of the substrate unit 34. The connector 34c is exposed to the mounting surface 11 of the first shell 10a through an opening in the first shell.

The control circuit board 12, a printed circuit board, is a rectangular structure that is substantially equal to the mounting surface 11 of the case 10 in length and width. The mounting surface 11 of the case 10 is formed having circular protrusions 70a and 70b that correspond to the spindle motor 22 and the bearing assembly 52, respectively. The control circuit board 12 is formed having circular openings 72a and 72b that correspond to the protrusions 70a and 70b, respectively. Four corner portions of the circuit board 12 are obliquely cut at, e.g., 45 degrees to each side, and individually form notch portions 77. A plurality of electronic components 74 and a connector 71 are mounted on the circuit board 12. Further, a flexible printed circuit board 76 for electrical connection between the HDD and an external device is connected to the circuit board 12. It is drawn out from one short side of the circuit board 12, and a plurality of connector terminals 75 are formed on its extended end.

The control circuit board 12 is overlapped on the mounting surface 11 of the case 10 and screwed to the first shell 10a with screws. As this is done, the circuit board 12 is located with its four sides aligned or coincident individually with four sides of the mounting surface 11. The connector 71 on the circuit board 12 is connected to the connector on the substrate unit 34.

The notch portions 77 at the four corner portions of the control circuit board 12 are situated corresponding individually to the four corner portions of the mounting surface 11. Thus, the four corner portions of the mounting surface 11 are exposed to the outside without being covered by the circuit board 12. The corner portions of the case 10, including the four exposed corner portions of the mounting surface 11, individually constitute retaining portions 78 for holding the case without contact with the circuit board 12.

According to the HDD with the above-mentioned configuration, the contact portion 87 of the clamp spring can easily be centered by the engaging portion 86a provided in the clamp spring 80 and the guide surface 44b provided in the clamp ring 44 for binding the clamp spring. Therefore, even in the case the inner diameter accuracy of the clamp spring 80 is relatively low, the center displacement of the clamp spring can be prevented. Therefore, there can be provided a disk drive device, capable of easily administering the parts accuracy and capable of fixing the disk without generating the center displacement of the clamp member, an HDD comprising the same, and a method of manufacturing a disk drive device.

Next, a disk drive device for an HDD according to a second embodiment of the present invention will be described. As shown in FIG. 11, according to this embodiment, the clamp ring 44 fitted to the upper end portion of the outer circumference of the hub 43 by a shrinkage fitting includes a peripheral edge portion disposed coaxially with the hub 43 on the side facing the clamp spring 80, and the peripheral edge portion constitutes an engaging portion 44c. The engaging portion 44c is not tapered. The clamp spring 80 integrally comprises an inner hole 80a through which the upper end portion of the hub 43 is inserted with a gap, a ring shaped contact portion 87 located on the radially outside of the inner hole, and an outer peripheral rim part 86 located radially outside of and coaxially with the contact portion. The contact portion 87 has an arc shaped cross section projecting toward the magnetic disk 20 and the projecting end elastically contacts with the inner circumferential edge portion of the magnetic disk 20 surface. The inner surface of the outer peripheral rim part 86 is formed in a tapered form coaxial with the contact portion 87 and constitutes a guide surface 86b. The engaging portion 44c of the clamp ring 44 is brought into contact with the guide surface 86b of the clamp spring 80 and presses the clamp spring 80 to the magnetic disk 20.

According to the second embodiment of the above-mentioned configuration, at the time of the shrinkage fitting of the clamp ring 44, according to the relative movement of the engaging portion 44c and the guide surface 86b, the contact portion 87 of the clamp spring can easily be centered. Even in the case the inner diameter accuracy of the clamp spring 80 is relatively low, the center displacement of the clamp spring can be prevented. Therefore, there can be obtained a disk drive device, capable of easily administering the parts accuracy and capable of fixing the disk without generating the center displacement of the clamp member and an HDD comprising the same.

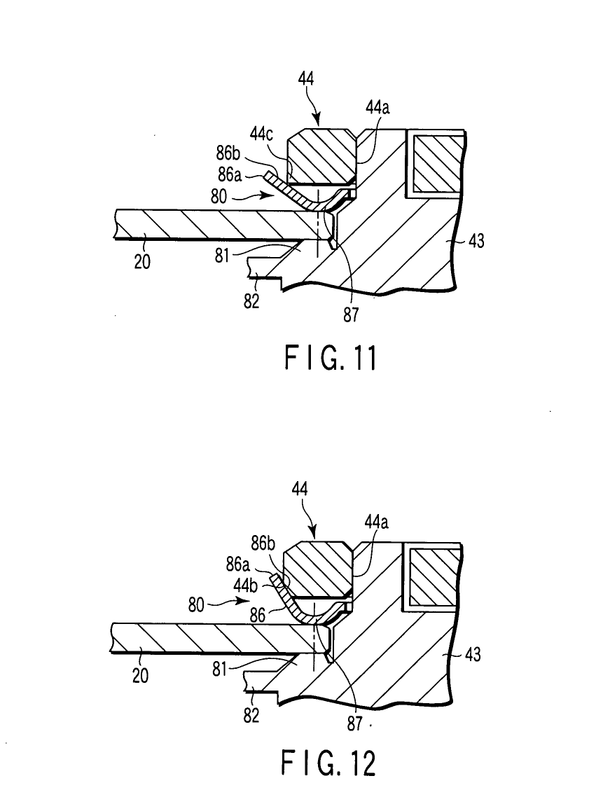

Next, a disk drive device for an HDD according to a third embodiment of the present invention will be explained. As shown in FIG. 12, according to this embodiment, the clamp ring 44 fitted to the outer circumference of the upper end portion of the hub 43 by the shrinkage fitting comprises a tapered outer peripheral rim part located coaxially with the hub 43 on the side facing the clamp spring 80, and the outer peripheral rim part constitutes a guide surface 44b. The clamp spring 80 integrally comprises an inner hole 80a through which the upper end portion of the hub 43 is inserted with a gap, a ring shaped contact portion 87 located radially outside of the inner hole, and an outer peripheral rim part 86 located coaxially with and radially outside of the contact portion 87. The contact portion 87 has an arc shaped cross section projecting toward the magnetic disk 20 and the projecting end elastically contacts with the inner circumferential edge portion of the magnetic disk 20 surface. The inner surface of the outer peripheral rim part 86 is formed in a tapered form concentrically with the contact portion 87 and provides the engaging portion 86b. The guide surface 44b of the clamp ring 44 and the engaging portion 86b of the clamp spring 80 are both formed in a tapered form and contact with each other. The guide surface 44b of the clamp ring 44 presses the clamp spring 80 to the magnetic disk 20 side.

According to the third embodiment of the above-mentioned configuration, at the time of the shrinkage fitting of the clamp ring 44, according to the relative movement of the guide surface 44b and the engaging portion 86b, the contact portion 87 of the clamp spring can easily be centered. Even in the case the inner diameter accuracy of the clamp spring 80 is relatively low, the center displacement of the clamp spring can be prevented. Therefore, there can be provided a disk drive device, capable of easily administering the parts accuracy and capable of fixing the disk without generating the center displacement of the clamp member, a HDD comprising the same, and a method of manufacturing a disk drive device.

In the second and third embodiments, the other configurations are same as those of the above-mentioned first embodiment so that the same reference numerals are applied to the same parts with the detailed explanation thereof omitted.

This invention is not limited directly to the embodiments described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

In the above-mentioned embodiments, the tapered guide surface provided in the clamp ring or the clamp spring can be formed not always over the entire circumference but also intermittently in the circumferential direction. The number of the magnetic disk and the head is not limited to one and they may be increased as needed. Furthermore, the magnetic disk is not limited to those of 0.85 inch but it may be of 1.8 inches or 2.5 inches.

What is claimed is:

1. A disk drive device comprising:
a spindle motor having a pivot and a substantially cylindrical hub configuring a rotor and supported rotatably on the pivot;
a disk shaped recording medium fitted coaxially to an outer circumference of the hub;
an elastic annular spacer including a contact portion which is in contact with the recording medium, and mounted on an end portion of the outer circumference of the hub with a gap; and
a ring shaped clamp member fitted to the end portion of the outer circumference of the hub by a shrinkage fitting, the clamp member holding the spacer in a state contacted with the recording medium,
one of the spacer and clamp member having an engaging portion which engages with the other member at the time of the shrinkage fitting of the clamp member, and the other of the spacer and clamp member having a guide surface which contacts with the engaging portion of the member and guides the spacer in a direction wherein a center of the contact portion of the spacer coincides with a rotation center of the hub.

2. The disk drive device according to claim 1, wherein the clamp member has a tapered guide surface formed on an outer peripheral portion on the side facing the spacer and located coaxially with the hub,
the spacer has an inner hole through which the hub is inserted with a gap,
the contact portion of the spacer is formed in a ring shape and located radially outside of the inner hole, and
the spacer has an outer peripheral portion located coaxially with and radially outside of the contact portion and constituting the engaging portion.

3. The disk drive device according to claim 1, wherein the clamp member has a peripheral edge portion configuring the engaging portion, the peripheral edge portion being located coaxially with the hub on the side facing the spacer,
the spacer has an inner hole through which the hub is inserted with a gap,
the contact portion of the spacer is formed in a ring shape and located on radially outside of the inner hole, and
the spacer has a peripheral edge portion formed in a tapered form coaxially with the contact portion and configures the guide surface, the peripheral edge portion being located on radially outside of the contact portion.

4. The disk drive device according to claim 1, wherein the clamp member has a tapered guide surface formed in an outer peripheral edge portion on the side facing the spacer and located coaxially with the hub,
the spacer has an inner hole through which the hub is inserted with a gap,
the contact portion of the spacer is formed in a ring shape and located on radially outside of the inner hole, and
the spacer has a tapered peripheral edge portion located coaxially with and radially outside of the contact portion and constituting the engaging portion.

5. The disk drive device according to claim 1, wherein the spacer and the clamp member are made of the same material.

6. A disk apparatus comprising:
a case;
the disk drive device according to claim 1, arranged in the case;
a head which performs information processing on the recording medium; and
a head actuator which is arranged in the case and movably supports the head with respect to the recording medium.

7. A method of manufacturing a disk drive device comprising a spindle motor having a pivot and a substantially cylindrical hub configuring a rotor and supported rotatably on the pivot; a disk shaped recording medium fitted coaxially to an outer circumference of the hub; an elastic annular spacer including a contact portion which is in contact with the recording medium, and mounted on an end portion of the outer circumference of the hub with a gap; and a ring shaped clamp member fitted to the end portion of the outer circumference of the hub by a shrinkage fitting, the clamp member holding the spacer in a state contacted with the recording medium, the method comprising:
fitting the recording medium to the outer circumference of the hub of the spindle motor;
mounting the spacer onto an end portion of the outer circumference of the hub with a gap and bringing the contact portion of the spacer to contact with the recording medium; and
fitting the clamp member on the end portion of the outer circumference of the hub by a shrinkage fitting, and at the time, contacting an engaging portion provided on one of the spacer and the lamp member with a guide surface provided on the other so as to guide the spacer in a direction wherein a center of the contact portion of the spacer coincides with a rotation center of the hub for positioning.
